(19) United States
(12) Patent Application Publication
(10) Pub. No.: US 2017/0124630 A1
(43) Pub. Date: May 4, 2017

(54) METHOD AND SYSTEM FOR PROVIDING HOME SMART AND SIMPLE PURCHASING SERVICE BASED ON BARCODE SCANNING

(71) Applicant: INDUSTRIAL BANK OF KOREA, Seoul (KR)

(72) Inventors: Pilsoon SHIN, Busan (KR); Jongman KWON, Gwangju-si (KR)

(21) Appl. No.: 14/926,088

(22) Filed: Oct. 29, 2015

(51) Int. Cl. G06Q 30/06; G06K 7/14; G06Q 20/32

(52) U.S. Cl. CPC G06Q 30/0633; G06Q 20/3276; G06K 7/1413; G06K 2007/10524

(57) ABSTRACT

The present invention provides a method and system for providing a home smart and simple purchasing service based on barcode scanning. According to a first aspect of the present invention, the method for providing a home smart and simple purchasing service based on barcode scanning includes performing, by a barcode scan module 12a, a barcode scan on a desired product when power is applied to a first type smart barcode terminal 10a corresponding to a standalone type (Type 1) including the barcode scan module 12a, and performing, by a mobile terminal 20, a purchase of the product on which the barcode scan has been performed through a payment method and a payment confirmation method provided from a service server 30.

### BACKGROUND

1. Field of the Invention

The present invention relates to a method and system for providing a home smart and simple purchasing service based on barcode scanning, and more particularly, to a method and system for providing a home smart and simple purchasing service based on barcode scanning, which may enable immediate acquisition of product information through barcode scanning.

2. Discussion of Related Art

Although customers use e-commerce services using mobile terminals such as a feature phone or a smart phone, wired terminals such as a PC or a laptop, and the like, there have been a lot of inconvenient procedures such as finding goods, payment, and the like when performing e-commerce.

Accordingly, in a case in which a customer purchases a desired product at home via the e-commerce, there has been a need for simplifying procedures for receiving a type, a model name, and the like of the product, and even for the customer who purchases the product, there has been a need for more simplified procedures for a purchasing method.

Meanwhile, in a case of a barcode scanner, it has been utilized in on-site logistics management, store merchandise management, and the like in terms of industries, but goods and services for personal user-centric utilization are in an insufficient state. In addition, there are products which can be purchased based on the barcode scanning, but the products are equipped with W-Fi so they are only available in specific areas, and there is no product that can be utilized in a universal area.

Therefore, in the present invention, there is provided a simple purchasing method based on barcode scanning.

### SUMMARY OF THE INVENTION

The present invention is directed to a method and system for providing a home smart and simple purchasing service based on barcode scanning, which may enable immediate acquisition of product information through barcode scanning.

The present invention is also directed to a method and system for providing a home smart and simple purchasing service based on barcode scanning, which may provide personalized and customized services through big data utilization by collecting information about a barcode product using a product search engine, and provide the best product at a reasonable price in a personalized and customized manner by providing analysis information through big data utilization.

The present invention is also directed to a method and system for providing a home smart and simple purchasing service based on barcode scanning, which may purchase the same product which a user desires to purchase only through a simple operation to contribute to revitalization of the e-commerce market.

The present invention is also directed to a method and system for providing a home smart and simple purchasing service based on barcode scanning, which may be universally available using Wi-Fi and a mobile communication module (3G or 4G) without being bound to a place so it may be utilized in various services through a mobile terminal including a computing function such as a smart phone.

However, objects of the present invention are not limited to the above-mentioned objects, and other objects which are not mentioned will become apparent to those skilled in the art from the following description.

According to an aspect of the present invention, there is provided a method for providing a home smart and simple purchasing service based on barcode scanning, including: performing, by a barcode scan module 12a, a barcode scan on a desired product when power is applied to a first type smart barcode terminal 10a corresponding to a standalone type (Type 1) including the barcode scan module 12a; and performing, by a mobile terminal 20, a purchase of the product on which the barcode scan has been performed through a payment method and a payment confirmation method provided from a service server 30.

Here, the performing of the purchase may include providing, by the service server 30, payment method information and payment confirmation information to the mobile terminal 20 by an SMS push method when the mobile terminal 20 is a feature phone and by the SMS push method or a data push method when the mobile terminal 20 is a smart phone, in an automatic payment method utilizing payment information registered in advance in the first type smart barcode terminal 10a, and performing a cheapest product payment service for a user utilizing a big data DB.

According to another aspect of the present invention, there is provided a method for providing a home smart and simple purchasing service based on barcode scanning, including: connecting a mobile terminal 20 to a USB interface 17b of a second type smart barcode terminal 10b corresponding to an accessory type (Type 2), or connecting the mobile terminal 20 to a 3.5 pi earphone jack interface 17c of a third type smart barcode terminal 10c corresponding to Type 3; downloading and installing a user app from a service server 30 when the user app is not installed in a case in which the mobile terminal 20 is a smart phone, and then executing the user app; performing, by the user app, a registration when user information and payment information are not registered on the service server 30; performing, by a barcode scan module 12b of the second type smart barcode terminal 10b or a barcode scan module 12c of the third type smart barcode terminal 10c, a barcode scan on a desired product; and performing, by the user app, a purchase of the product on which the barcode scan has been performed, through confirmation of detailed information of the product and payment for the product which are provided from the service server 30.

According to still another aspect of the present invention, there is provided a system for providing a home smart and simple purchasing service based on barcode scanning, including: a smart barcode terminal that performs a barcode scan on a desired product using a barcode scan module when power is applied to the smart barcode terminal; and a mobile terminal that performs a purchase of the product on which the barcode scan has been performed through a payment method provided from a service server.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view showing a first type smart barcode terminal in a system for providing a home smart and simple purchasing service based on barcode scanning according to an embodiment of the present invention;

FIGS. 2A and 2B are views showing second type smart barcode terminals and third type smart barcode terminals in systems for providing a home smart and simple purchasing service based on barcode scanning according to embodiments of the present invention;

FIG. 3 is a view showing a system for providing a home smart and simple purchasing service based on barcode scanning according to an embodiment of the present invention;

FIG. 4 is a view showing a process by a user app of a mobile terminal in a method for providing a home smart and simple purchasing service based on barcode scanning according to an embodiment of the present invention;

FIG. 5 is a view showing a process by a service server in a method for providing a home smart and simple purchasing service based on barcode scanning according to an embodiment of the present invention; and

FIG. 6 is a view showing a process by a first type smart barcode terminal and a second type smart barcode terminal in a method for providing a home smart and simple purchasing service based on barcode scanning according to an embodiment of the present invention.

### DETAILED DESCRIPTION OF EXEMPLARY EMBODIMENTS

Hereinafter, preferred embodiments according to the present invention will be described with reference to the accompanying drawings. In the following description, detailed descriptions with regard to the prior arts and construction that might unnecessarily obscure the subject matter of the present invention are to be omitted.

In the present specification, if any one of the components “transmits” data or signals to another component, it means that the component can transmit the data or signals to the other component directly or through at least one other component.

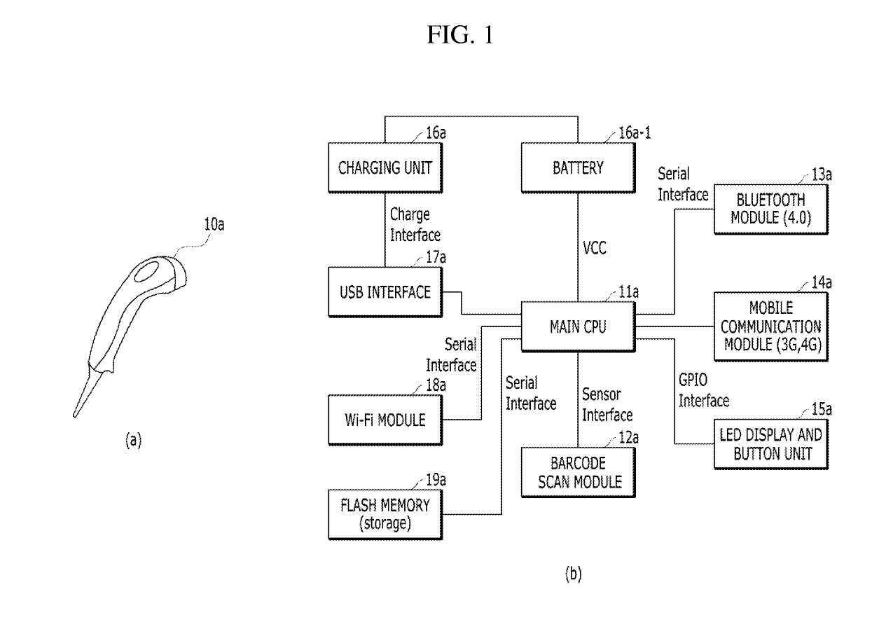

FIG. 1 is a view showing a first type smart barcode terminal 10a in a system for providing a home smart and simple purchasing service based on barcode scanning according to an embodiment of the present invention. Referring to FIG. 1, the first type smart barcode terminal 10a includes a main CPU 11a, a barcode scan module 12a, a Bluetooth module 13a, a mobile communication module 14a, an LED display and button unit 15a for displaying an operating state, a charging unit 16a through a USB interface 17a, a battery 16a-1, the USB interface 17a, a Wi-Fi module 18a, and a flash memory 19a for storing data. A module in the present specification may refer to a functional and structural combination of hardware for performing the scope of the present invention and software for driving the hardware. For example, the module may refer to a predetermined code and a logical unit of a hardware resource for performing the predetermined code, and it can be easily deduced by a person with average knowledge in the technical field of the present invention that it may not necessarily refer to a physically connected code or one type of hardware.

The first type smart barcode terminal 10a may perform a function independently without the need of a mobile terminal 20 as a basic type of standalone type, and include the mobile communication module 14a to transmit scan information to the outside even in outdoors as well as indoors, that is, without being bound to a place. That is, the first type smart barcode terminal 10a may be connected directly to a service server 30 through a mobile communication network (not shown) using the mobile communication module 14a, so that services may be used without the connection of separate equipment.

Here, the mobile communication network may be a synchronous mobile communication network or an asynchronous mobile communication network. As an example of the asynchronous mobile communication network, a communication network of a WCDMA (Wideband Code Division Multiple Access) method may be given. In this case, although not shown, the mobile communication network may include an RNC (Radio Network Controller), an asynchronous MSC (Mobile Switching Center), and the like. Meanwhile, a WCDMA network has been given as an example, but the fact that the mobile communication network can be changed to a next generation mobile communication network such as a 3G network, an LTE network, a 4G network, or the like is well known.

The main CPU 11a may be connected to the mobile terminal 20 by a Wi-Fi method through the Wi-Fi module 18a and a Bluetooth method through the Bluetooth module 13a, and then perform data communication with the service server 30 by connecting to the service server 30 through the mobile terminal 20 and a wired terminal 40 corresponding to a smart device including a computing function other than PC.

In addition, the main CPU 11a may provide a service for determining a location of a barcode scanner by a Bluetooth BLE method with the mobile terminal 20 through the Bluetooth module 13a, and for this, the main CPU 11a may control the LED display and button unit 15a to express a flashing signal when the mobile terminal 20 approaches the main CPU 11a.

The main CPU 11a may provide a product payment service by utilizing a mobile communication module such as 3G, 4G, or the like of the mobile terminal 20 through the interlocking with the mobile terminal 20 by a Bluetooth method through the Bluetooth module 13a.

That is, the first type smart barcode terminal 10a can be connected directly to the service server using the mobile communication module 14a corresponding to the mobile communication module (3G or LTE) of the terminal 10a itself, so that services may be used without the connection of separate equipment.

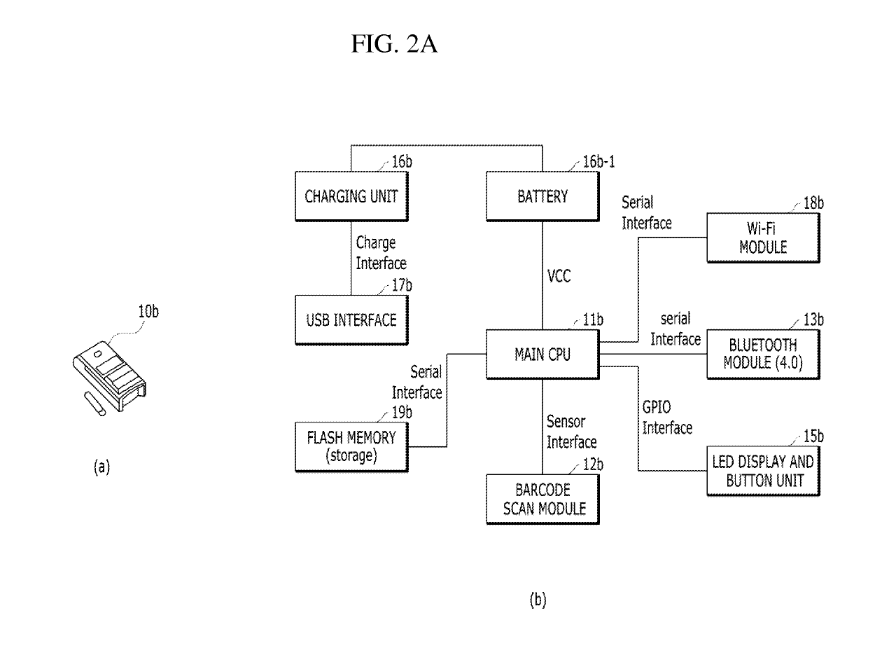

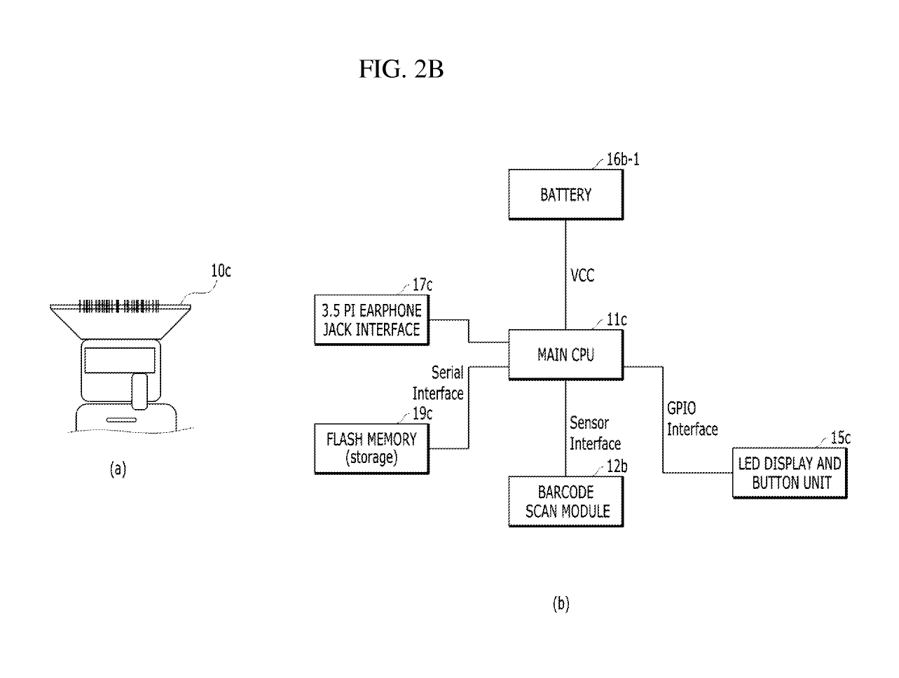

FIG. 2A is a view showing a second type smart barcode terminal 10b in a system for providing a home smart and simple purchasing service based on barcode scanning according to an embodiment of the present invention. Referring to FIG. 2A, the second type smart barcode terminal 10b includes a main CPU 11b, a barcode scan module 12b, a Bluetooth module 13b, an LED display and button unit 15b, a charging unit 16b, a battery 16b-1, a USB interface 17b, a Wi-Fi module 18b, and a flash memory 19b.

The second type smart barcode terminal 10b may be provided so as to be attached to the mobile terminal in the form of an accessory and connected to the mobile terminal 20 through the connection with the USB interface 17b to thereby receive a power source from the mobile terminal 20, and share a data interface with the mobile terminal 20.

On one side of the second type smart barcode terminal 10b, a connection line mounting portion provided in the form of a strap rack for improving the access to the mobile terminal 20 is formed as shown in FIG. 2A.

The main CPU 11b may control the USB interface 17b in a wired method or the Bluetooth module 13b and the Wi-Fi module 18b in a wireless method in order to perform data communication with the service server 30 through the mobile communication module such as 3G, 4G, or the like of the mobile terminal 20.

Thus, through the connection of a USB terminal to the mobile terminal 20 corresponding to the smart phone or the like in the form of the accessory, product payment utilizing 3G or LTE mobile communication of the smart phone may be made possible, and the connected USB terminal may be utilized as a power source or a data interface.

In addition, through the Bluetooth interlocking with the mobile terminal 20 corresponding to the smart phone or the like, product payment utilizing 3G or LTE mobile communication of the smart phone may be made possible.

In addition, the main CPU 11b performs a storage function to the flash memory 19b for the purpose of rapid data utilization for information (barcode information or the like) whose use frequency is a predetermined threshold value or more.

The main CPU 11b performs control for an LED device on the LED display and button unit 15a for expressing the operation of the barcode scan module 12b, the charging to the charging unit 16b through the USB interface 17b, the operation of the Wi-Fi module 18b, the operation of the Bluetooth module 13b, and the like.

In the same manner as that in the above-described main CPU 11a, the main CPU 11b may provide a service for determining a location of a barcode scanner by a Bluetooth BLE method with the mobile terminal 20 through the Bluetooth module 13b, and for this, the main CPU 11b may control the LED display and button unit 15b to express a flashing signal when the mobile terminal 20 approaches the main CPU 11b, and provide a product payment service by utilizing the mobile communication module such as 3G, 4G, or the like of the mobile terminal 20 through the interlocking with the mobile terminal 20 by a Bluetooth method through the Bluetooth module 13b.

FIG. 2B is a view showing a third type smart barcode terminal 10c in a system for providing a home smart and simple purchasing service based on barcode scanning according to an embodiment of the present invention. Referring to FIG. 2B, the third type smart barcode terminal 10c includes a main CPU 11c, a barcode scan module 12c, an LED display and button unit 15c, a battery 16c-1, a 3.5 pi earphone jack interface 17c, and a flash memory 19c.

Here, the third type smart barcode terminal 10c may be connected to a 3.5 earphone jack that is usually formed at the top of the mobile terminal 20 such as a feature phone, a smart phone, or the like through the 3.5 pi earphone jack interface 17c, and thereby provide a product payment service using the 3G or LTE mobile communication of the smart phone.

The third type smart barcode terminal 10c includes only the 3.5 pi earphone jack interface 17c corresponding to a 3.5 earphone jack connection unit and the barcode scan module 12c as the main components without any wireless module.

Here, the mobile terminal 20 may supply a power source to the third type smart barcode terminal 10c and communicate with the third type smart barcode terminal 10c through the 3.5 pi earphone jack, and include the flash memory 19c for performing storage of partial barcode information for the purpose of rapid data utilization of frequently used information or the like.

The third type smart barcode terminal 10c may be usefully available even in a feature phone as well as a smart phone, and in the case of the feature phone, only a payment service is possible and other information cannot be confirmed.

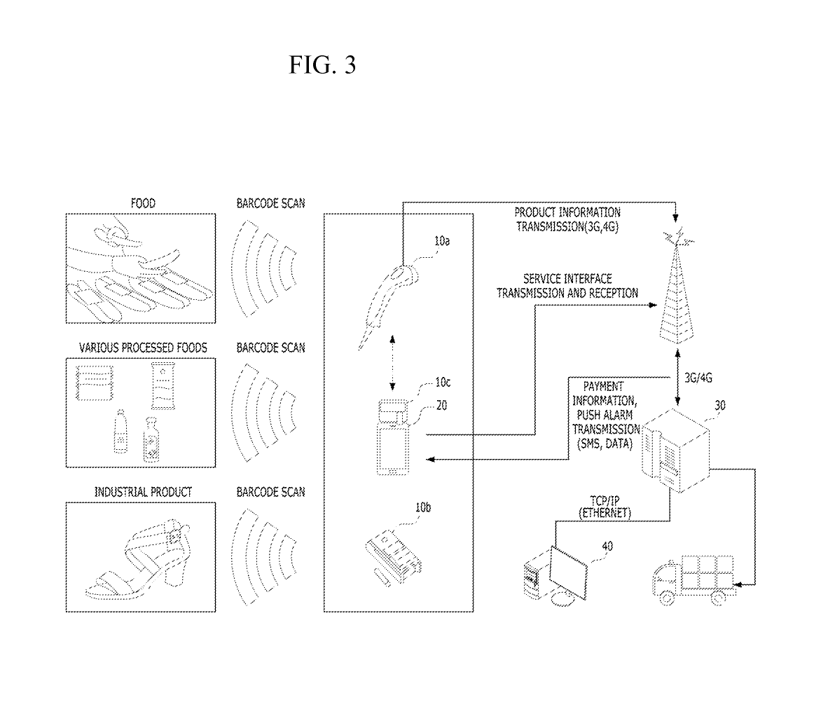

FIG. 3 is a view showing a system for providing a home smart and simple purchasing service based on barcode scanning according to an embodiment of the present invention. Referring to FIG. 3, it is desirable that the service server 30 and a user app that is executed in the mobile terminal 20 are further provided other than the above-described first and second type smart barcode terminals 10a and 10b.

Here, the service server 30 (1) utilizes a crawler and a web collection tool in order to activate an SDCR (Scan Data Collection Robot), (2) utilizes a big data technique in order to collect barcode product information (price, usage, etc.) and make a database for each category, (3) provides user information and payment processing service corresponding to big data processing, (4) provides a web interface in order to monitor product information and payment information, (5) provides user analysis data such as product purchase details of a user, similar product recommendation information, statistics, a purchase pattern, and the like, (6) provides data push using a mobile SMS push function and a dedicated smart phone app with respect to payment and product details, and (7) performs user-customized search for the lowest price utilizing a big data DB in order to provide the lowest price search service of a barcode scan product.

Meanwhile, a “user app” corresponding to the dedicated smart phone app executed in the mobile terminal 20 (1) notifies data push information about payment information (details) according to the execution of the user app, (2) provides a product information service and payment service by the interlocking with the second and third type smart barcode terminals 10b and 10c corresponding to an accessory type scanner through the user app, (3) provides a user service subscription and related information registration interface, (4) provides a mirror type interface (service server connection module) through the connection with the service server 30, and (5) provides location search services of the first, the second and the third type smart barcode terminals 10a, 10b, and 10c corresponding to the barcode scanner through Bluetooth.

By the above-described configuration, the system for providing a home smart and simple purchasing service based on barcode scanning may directly use the first, the second, and the third type smart barcode terminals 10a, 10b, and 10c corresponding to the barcode scanner in the corresponding product and thereby may establish a foundation for reasonable purchase of the same product.

In short, the first type smart barcode terminal 10a corresponding to Type 1 may perform data transmission/reception directly with the service server 30 through the mobile communication module 14a corresponding to 3G, LTE, and 4G modems of the first type smart barcode terminal 10a itself. Meanwhile, the second type smart barcode terminal 10b corresponding to Type 2 may perform data transmission/reception with the service server 30 through the mobile communication module of the mobile terminal 20 by the user app, in conjunction with the mobile terminal 20 by controlling the Bluetooth module 13b.

In addition, the third type smart barcode terminal 10c corresponding to Type 3 may be interlocked with the mobile terminal 20 corresponding to a smart phone, a feature phone, or the like by utilizing a 3.5 AUX port corresponding to the 3.5 pi earphone jack interface 17c, and utilize the 3G and LTE modems of the mobile terminal 20.

The mobile terminal 20 may provide location search services of the first, the second, and the third type smart barcode terminals 10a, 10b, and 10c corresponding to the barcode scanner utilizing Bluetooth through the user app.

Meanwhile, the service server 30 performs alarm transmission of payment information push. That is, when the mobile terminal 20 is a feature phone, the service server 30 transmits an alarm in an SMS push method, and when the mobile terminal 20 is a smart phone, the service server transmits an alarm in the SMS push method or a data push (user app) method.

The service server 30 provides a service interface in the form of a user web and transmits the service interface to the user app to perform synchronization with respect to the user app, and performs permission and interruption on the connection via Ethernet using TCP/IP even using the wired terminal 40 such as a user PC or the like.

Hereinafter, operating scenarios through the above-described configuration will be described.

### <First Scenario>

As power is applied to the first type smart barcode terminal 10a corresponding to the standalone type (Type1) while including the barcode scan module 12a, the barcode scan module 12a performs barcode scan on a desired product.

Next, purchase of the product is performed through an SMS payment method and an SMS payment confirmation method provided from the service server 30 through the mobile terminal 20 of a user.

That is, in the case of the first scenario, payment method information of an SMS push method or a data push method and other payment information can be confirmed regardless of a user phone environment in an automatic payment method utilizing payment information having been registered in advance, with respect to the first type smart barcode terminal 10a of the standalone type. In addition, in the case of the first scenario, a product payment service for the lowest price utilizing the big data DB of the service server 30 is possible.

### <Second Scenario>

The mobile terminal 20 is connected to the USB interface 17b and the 3.5 pi earphone jack interface 17c of each of the second type smart barcode terminal 10b corresponding to an accessory type (Type 2) and the third type smart barcode terminal 10c corresponding to Type 3.

When a user app is not installed in a case in which the mobile terminal 20 is a smart phone, the user app is downloaded and installed from the service server 30, and then the user app is executed. The user app performs registration when user information and payment information is not registered on the service server 30.

The barcode scan module 12b of the second type smart barcode terminal 10b and the barcode scan module 12c of the third type smart barcode terminal 10c perform barcode scan on a desired product.

Accordingly, the user app provides other services such as confirmation of details of a product to be settled, and the like.

That is, in the case of the second scenario, it is possible to provide more advanced services through the user app. It is possible to notify a product price utilizing user payment location information, register and correct user payment information, and provide other services such as detailed information about the scanned product.

### <Third Scenario>

Product scan is performed by any one of the first type smart barcode terminal 10a corresponding to Type 1, the second type smart barcode terminal 10b corresponding to Type 2, and the third type smart barcode terminal 10c corresponding to Type 3.

Payment information is confirmed in the mobile terminal 20.

The wired terminal 40 such as a user PC is connected to a service domain of the service server 30, and then performs service utilization such as product information confirmation, user information registration, payment information registration and correction.

In the case of the third scenario, services may be received by accessing and controlling the web interface of the service server 30 using the wired terminal 40 regardless of the type of the barcode scanner such as Type 1, Type 2, and Type 3. That is, in a case of using the mobile terminal 20 such as a smart phone, it is connected to the service server 30 in the form of an app, and in a case of utilizing the wired terminal 40 such as a PC, the corresponding service may be provided through a user authentication process of the service domain. In addition, in the case of the third scenario, it is possible to provide a search service for the cheapest product utilizing the big data DB of the service server 30 and a user-customized recommendation information service.

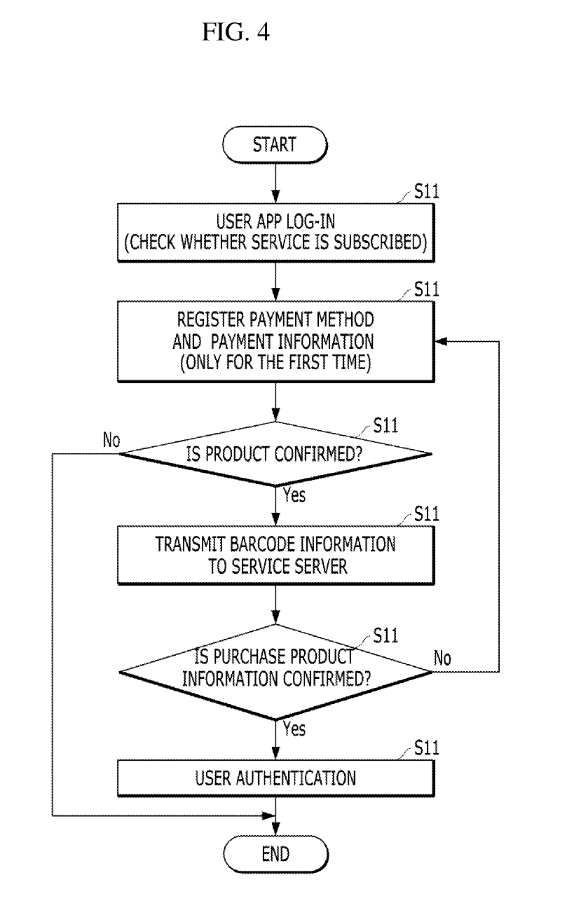

FIG. 4 is a view showing a process by a user app of the mobile terminal 20 in a method for providing a home smart and simple purchasing service based on barcode scanning according to an embodiment of the present invention. Referring to FIG. 4, in operation S11, the user app of the mobile terminal 20 determines whether the corresponding service is registered by performing a login to the service server 30.

Next, in operation S12, the user app performs registration of a payment method such as an SMS payment method or the like and payment information to the service server 30 only for the first time.

Next, in operation S13, the user app confirms a product corresponding to whether there is a product which is barcode-scanned by the second type smart barcode terminal 10b and the third type smart barcode terminal 10c.

In operation S14, when the product is confirmed based on the confirmation result of operation S13, the user app transmits barcode information to the service server 30 through a mobile communication network. Conversely, when the product is not confirmed based on the confirmation result of operation S13, the user app terminates the corresponding service.

Next, in operation S15, the user app determines whether purchase product information is confirmed according to the barcode information transmitted by the service server 30.

When the purchase product information is confirmed based on the confirmation result of operation S15, the user app performs user authentication from the relationship with the service server 30 and then terminates the corresponding service in operation S16, and conversely, when the purchase product information is not confirmed based on the confirmation result of operation S15, the user app returns to operation S13.

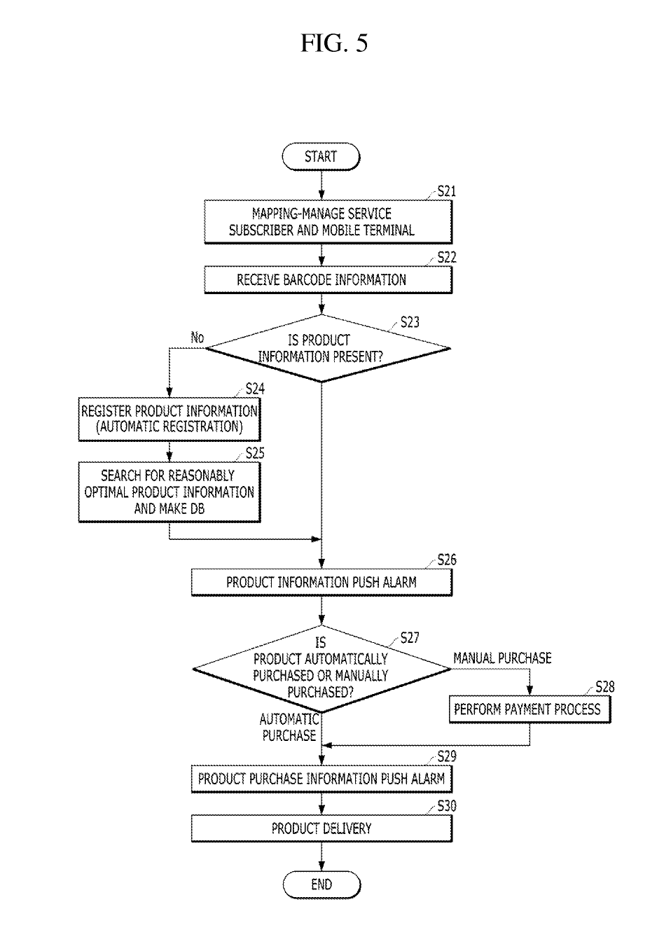

FIG. 5 is a view showing a process by the service server 30 in a method for providing a home smart and simple purchasing service based on barcode scanning according to an embodiment of the present invention. Referring to FIG. 5, in operation S21, the service server 30 performs mapping management between at least one of the first type smart barcode terminal 10a, the second type smart barcode terminal 10b, and the third type smart barcode terminal 10c with the mobile terminal 20, with respect to a service subscriber who simultaneously possesses one of the first type smart barcode terminal 10a, the second type smart barcode terminal 10b, and the third type smart barcode terminal 10c and the mobile terminal 20.

More specifically, the first type smart barcode terminal 10a may manage mapping with a feature phone of the mobile terminal 20, and the second type smart barcode terminal 10b and the third type smart barcode terminal 10c may manage mapping with a smart phone of the mobile terminal 20.

Next, in operation S22, the service server 30 receives barcode information from the first type smart barcode terminal 10a and the smart phone of the mobile terminal 20.

In operation S23, the service server 30 determines whether product information corresponding to the received barcode information is present.

When the product information is absent based on the determination result of operation S23, the service server 30 automatically performs registration of the product information corresponding to the barcode information in operation S24, and performs reasonably optimal product information searching and makes a DB so as to register the product information in operation S25.

Meanwhile, when the product information is present based on the determination result of operation S23 or when the DB is completely made in operation S25, the service server 30 performs a product information push alarm for the product information through an SMS push method when the mobile terminal 20 is the feature phone, and performs the product information push alarm for the product information through the SMS push method or a data push method when the mobile terminal 20 is the smart phone in operation S26.

In operation S27, the service server 30 determines whether the barcode-scanned product is to be automatically purchased or manually purchased based on mapping information of operation S21.

When the barcode-scanned product is to be manually purchased based on the determination result of operation S27, the service server 30 performs a payment process by the user app of the wired terminal 40 such as a PC or the mobile terminal 20, and proceeds to operation S29.

Meanwhile, when the barcode-scanned product is to be automatically purchased based on the determination result of operation S27, or when the barcode-scanned product is to be manually purchased or the payment process is performed in operation S28, the service server 30 performs a product purchase information push alarm in operation S29. Next, in operation S30, product delivery is performed by an off-line process. Meanwhile, in operation S29, the service server 30 performs the product purchase information push alarm for the product purchase information in the SMS push method when the mobile terminal 20 is the feature phone, and performs the product purchase information push alarm for the product purchase information in the SMS push method or the data push method when the mobile terminal 20 is the smart phone, in the same manner as that in operation S26.

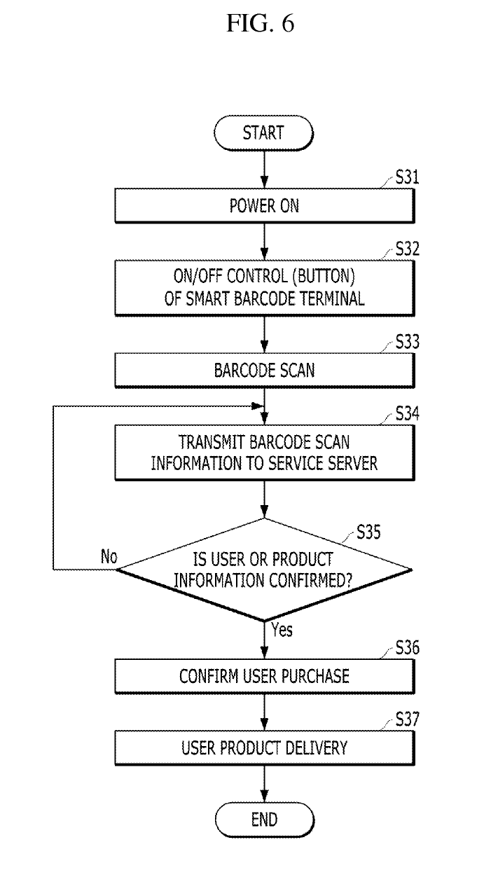

FIG. 6 is a view showing a process by the first type smart barcode terminal 10a and the second type smart barcode terminal 10b in a method for providing a home smart and simple purchasing service based on barcode scanning according to an embodiment of the present invention. Referring to FIG. 6, in operation S31, power of one of the first type smart barcode terminal 10a, the second type smart barcode terminal 10b, and the third type smart barcode terminal 10c is turned ON.

In operation S32, each of the first type smart barcode terminal 10a, the second type smart barcode terminal 10b, and the third type smart barcode terminal 10c receives an input of an ON/OF control button with respect to barcode scan in the LED display and button unit 15a of the first type smart barcode terminal 10a, the LED display and button unit 15b of the second type smart barcode terminal 10b, and the LED display and button unit 15c of the third type smart barcode terminal 10c.

In operation S33, each of the first type smart barcode terminal 10a, the second type smart barcode terminal 10b, and the third type smart barcode terminal 10c scans a barcode of the corresponding product by the barcode scan module 12a and the barcode scan module 12b.

In operation S34, the first type smart barcode terminal 10a transmits barcode scan information directly to the service server 30 through the mobile communication module 14a, and the second type smart barcode terminal 10b and the third type smart barcode terminal 10c transmit the barcode scan information to the service server 30 by the mobile communication module of the mobile terminal 20 through the connection with the mobile terminal 20 and the USB interface 17b.

In operation S35, the service server 30 determines whether user information and product information can be confirmed.

In operation S36, when the user information and the product information are confirmed based on the determination result of operation S35, the service server 30 enables user purchase confirmation to be performed through the SMS push method or the data push method in the case of the second type smart barcode terminal 10b and the third type smart barcode terminal 10c, and enables the user purchase confirmation through the SMS push method or the data push method according to the type of the mobile terminal 20 in the case of the first type smart barcode terminal 10a. That is, in the case of the first type smart barcode terminal 10a, when the mobile terminal 20 is the feature phone, the user purchase confirmation is performed through the SMS push method, and when the mobile terminal 20 is the smart phone, the user purchase confirmation is performed through the SMS push method or the data push method.

In operation S37, product delivery is performed by an off-line process.

As described above, the method and system for providing a home smart and simple purchasing service based on barcode scanning according to an embodiment of the present invention may enable immediate acquisition of product information through barcode scanning.

In addition, the method and system for providing a home smart and simple purchasing service based on barcode scanning according another embodiment of the present invention may provide personalized and customized services through big data utilization by collecting information about a barcode product using a product search engine of a service server, and provide the best product at a reasonable price in a personalized and customized manner by providing analysis information through big data utilization.

In addition, the method and system for providing a home smart and simple purchasing service based on barcode scanning according another embodiment of the present invention may purchase the same product which a user desires to purchase only through a simple operation to contribute to revitalization of the e-commerce market.

In addition, the method and system for providing a home smart and simple purchasing service based on barcode scanning according another embodiment of the present invention may be universally available only through provision of barcode information without being bound to a place such as a house or a mart using Wi-Fi and a mobile communication module (3G or 4G), so it may be utilized in various services utilizing a smart phone.

The embodiments of present invention can also be implemented as a computer-readable code in a computer-readable recording medium. The computer-readable recording medium includes any type of recording device in which data can be stored.

Examples of the computer-readable recording medium include a ROM, a RAM, a CD-ROM, a magnetic tape, a floppy disk, an optical data storage device, and the like, and also include a computer-readable recording medium that can be implemented in the form of carrier waves (for example, transmission through the Internet).

In addition, the computer-readable recording medium may be distributed over network-coupled computer systems so that the computer-readable code may be stored and executed in a distributed fashion. Also, functional programs, codes, and code segments for accomplishing the present invention may be easily construed by programmers skilled in the art to which the present invention pertains.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for providing a home smart and simple purchasing service based on barcode scanning, the method comprising:
performing, by a barcode scan module 12a, a barcode scan on a desired product when power is applied to a first type smart barcode terminal 10a corresponding to a standalone type (Type 1) including the barcode scan module 12a; and
performing, by a mobile terminal 20, a purchase of the product on which the barcode scan has been performed through a payment method and a payment confirmation method provided from a service server 30.

2. The method of claim 1, wherein the performing of the purchase includes providing, by the service server 30, payment method information and payment confirmation information to the mobile terminal 20 by an SMS push method when the mobile terminal 20 is a feature phone and by the SMS push method or a data push method when the mobile terminal 20 is a smart phone, in an automatic payment method utilizing payment information registered in advance in the first type smart barcode terminal 10a, and performing a cheapest product payment service for a user utilizing a big data DB.

3. A method for providing a home smart and simple purchasing service based on barcode scanning, the method comprising:
connecting a mobile terminal 20 to a USB interface 17b of a second type smart barcode terminal 10b corresponding to an accessory type (Type 2), or connecting the mobile terminal 20 to a 3.5 pi earphone jack interface 17c of a third type smart barcode terminal 10c corresponding to Type 3;
downloading and installing a user app from a service server 30 when the user app is not installed in a case in which the mobile terminal 20 is a smart phone, and then executing the user app;
performing, by the user app, a registration when user information and payment information are not registered on the service server 30;
performing, by a barcode scan module 12b of the second type smart barcode terminal 10b or a barcode scan module 12c of the third type smart barcode terminal 10c, a barcode scan on a desired product; and
performing, by the user app, a purchase of the product on which the barcode scan has been performed, through confirmation of detailed information of the product and payment for the product which are provided from the service server 30.

4. A system for providing a home smart and simple purchasing service based on barcode scanning, the system comprising:
a smart barcode terminal that performs a barcode scan on a desired product using a barcode scan module when power is applied to the smart barcode terminal; and
a mobile terminal that performs a purchase of the product on which the barcode scan has been performed through a payment method provided from a service server.
